(19) United States
(12) Patent Application Publication
(10) Pub. No.: US 2014/0268962 A1
(43) Pub. Date: Sep. 18, 2014

(54) HYBRID DC/AC INVERTER

(71) Applicant: CYBER POWER SYSTEMS INC., Taipei (TW)

(72) Inventors: Sheng-Ta Lee, Taipei (TW); Chao-Yang Hsu, Taipei (TW)

(73) Assignee: Cyber Power Systems Inc.T, Taipei (TW)

(21) Appl. No.: 13/832,668

(22) Filed: Mar. 15, 2013

(51) Int. Cl. H02M 7/46

(52) U.S. Cl. CPC H02M 7/46
USPC 363/123

(57) ABSTRACT

A hybrid DC/AC inverter for converting DC power to AC power feed to a grid voltage system has an input circuit, a half/full bridge switchable circuit and an output circuit. The input circuit has two input terminals for connecting to a DC source and outputs the DC power. The half/full bridge switchable circuit can be operated in a buck mode based on amplitudes of the DC power and the grid voltage. The output circuit is for connecting to the grid voltage system. According to comparison results between of the DC power and the grid voltage, the half/full bridge switchable circuit is selectively operated in the buck mode to reduce switching loss and power consumption.

### BACKGROUND OF THE INVENTION

1. Field of the Invention

The present invention relates to a DC/AC inverter, particularly to a DC/AC inverter capable of reducing switching loss.

2. Description of the Prior Art

A DC/AC inverter is commonly applied in a solar energy system for converting DC power to AC power. The DC/AC inverters can be categorized as either half bridge configuration or full bridge configuration. With reference to FIG. 6, a half bridge DC/AC inverter comprises two capacitors C1, C2, a first switch S1, a second switch S2, a rectifying circuit 61.

The two capacitors C1, C2 are connected in series and further respectively connected to two DC power input terminals DC+, DC−. The first switch S1 and the second switch S2 are connected in series and further respectively connected to two DC power input terminals DC+, DC−. The rectifying circuit 61 is provided between a first node where the two capacitors C1, C2 are connected in series and a second node where the two switches S1, S2 are connected in series. The rectifying circuit 61 comprises two diodes D1, D2 connected in opposite directions, and two switching elements S3, S4 respectively connected to the two diodes D1, D2 in parallel.

When grid voltage 62 is in positive cycles, the first switch S1 is operated in a switching mode and the second switch S2 is turned off. The inverter outputs a positive half DC voltage (+DC/2) when the first switch S1 is turned on and the second switch S2 is turned off. When the first, second and fourth switches S1, S2, S4 are turned off and the diode D2 and the third switch S3 are turned on, the freewheeling current occurs.

When the grid voltage 62 is in negative cycles, the second switch S2 is operated in a switching mode and the first switch S1 is turned off. In more detail, the inverter outputs a negative half DC voltage (−DC/2) when the second switch S2 is turned on and the first switch S1 is turned off. When the first, second and third switches S1, S2, S3 are turned off and the diode D1 and the fourth switch S4 are turned on, the freewheeling current occurs. By alternately turning on and off the two switches S1, S2, the inverter produces the positive or negative half DC voltages (+DC/2, −DC/2). Thus, a half bridge inverter has capability of converting a high DC voltage to a low DC voltage (DC/2) to reduce switching loss and power consumption, particularly suitable for electric systems using the relative small grid voltage 62.

With reference to FIG. 7, a common full bridge inverter comprises a DC capacitor C1, first to fourth switches S1-S4, two switches S1, S2, and two diodes D1, D2 respectively connected to the two switches S1, S2 in parallel. During positive cycles of the grid voltage 62, the first switch S1 is operated in a switching mode, the fourth switch S4 is turned on, and the second switch S2 and the third switch S3 are turned off. In more detail, the inverter outputs a positive DC voltage (+DC) when the first and fourth switches S1, S4 are turned on and the second and third switches S2, S3 are turned off. When the first, second and third switches S1, S2, S3 are turned off and the diode D2 and the fourth switch S4 are turned on, the freewheeling current occurs.

During negative cycles the grid voltage 62, the second switch S2 is operated in the switching mode, the third switch S3 is turned on and the first switch S1 and the fourth switch S4 are turned off. The inverter outputs a negative DC voltage (−DC) when the second and third switches S2, S3 are turned on and the first and fourth switches S1, S4 are turned off. When the first, second and fourth switches S1, S2, S4 are turned off, and the diode D1 and the third switch S3 are turned on, the freewheeling current occurs. Thus, a full bridge inverter is suitable for electric systems requiring the large grid voltage.

Therefore, the use of a full bridge inverter will bring a great benefit of high power converting efficiency in the electric systems that the grid voltage is greater than the half DC voltage. If the grid voltage is smaller than the half DC voltage, the full bridge inverter causes much power loss and the half bridge inverter will be more preferable.

With reference to FIG. 8 showing the signal (VInverter) of the inverter and the main voltage (VGrid), since amplitudes of the positive or negative DC voltages generated by the inverter are always greater than that of the grid voltage, either the half bridge inverter or the full bridge inverter encounters the problem of switching loss.

To overcome the shortcomings, the present invention provides a hybrid DC/AC inverter to mitigate or obviate the aforementioned problems.

### SUMMARY OF THE INVENTION

The main objective of the present invention is to provide a hybrid DC/AC inverter provided between a DC source and a grid voltage system for converting DC power to AC power by properly choosing different switching modes based on states of the received DC power and the grid voltage.

The hybrid DC/AC inverter has an input circuit, a half/full bridge switchable circuit and an output circuit. The input circuit has two input terminals for connecting to a DC source. The half/full bridge switchable circuit can be operated in a buck mode when the grid voltage is smaller than the DC power to convert the DC power to AC power, thereby reducing switching loss. The output circuit is for connecting to the grid voltage system. Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first preferred embodiment of a hybrid DC/AC inverter of the present invention;

FIG. 2 shows an output voltage produced by the hybrid DC/AC inverter of the present invention and a grid voltage output from a grid voltage system;

FIG. 3 is a circuit diagram of a second preferred embodiment of a hybrid DC/AC inverter of the present invention;

FIG. 4 is a circuit diagram of a third preferred embodiment of a hybrid DC/AC inverter of the present invention;

FIG. 5 is a circuit diagram of a fourth preferred embodiment of a hybrid DC/AC inverter of the present invention;

FIG. 6 is a circuit diagram of a conventional half bridge inverter;

FIG. 7 is a circuit diagram of a conventional full bridge inverter; and

FIG. 8 shows a voltage signal produced by the conventional inverter and a grid voltage.

### DETAILED DESCRIPTION OF THE PREFERRED EMBODIMENTS

With reference to FIG. 1, a hybrid DC/AC inverter of the present invention is connected between a DC source 10 and a grid voltage system 50 and has an input circuit 20, a half/full bridge switchable circuit 30 and an output circuit 40.

The input circuit 20 includes a positive input terminal +DC, a negative input terminal −DC and two capacitors C1, C2. The two capacitors C1, C2 have their first ends connected together to form a first node V1 and their second ends respectively connected to the positive input terminal +DC and the negative input terminal −DC.

The half/full bridge switchable circuit 30 includes a full bridge switching unit 31, a half bridge rectifying unit 32 and a controller 33.

The full bridge switching unit 31 is connected to the positive input terminal +DC and the negative input terminal −DC and comprises first to fourth switches S1-S4. The first switch S1 and the second switch S2 have their one ends connected together to form a second node V2 and their the other ends respectively connected to the positive input terminal +DC and the negative input terminal −DC. Similarly, the third switch S3 and the fourth switch S4 have their one ends connected together to form a third node V3 and their the other ends respectively connected to the positive input terminal +DC and the negative input terminal −DC. A fourth diode D4 and a third diode D3 are respectively connected in parallel to the first and second switches S1, S2. The half bridge rectifying unit 32 shares the third switch S3 and the fourth switch S4 with the full bridge switching unit 31 and further includes a fifth switch S5, a sixth switch S6, a first diode D1, and a second diode D2. The fifth switch S5 and the sixth switch S6 are connected in series between the first node V1 and the second node V2. The two diodes D1, D2 are connected in parallel to the fifth switch S5 and the sixth switch S6 respectively, wherein cathodes of the two diodes D1, D2 are respectively connected to the first node V1 and the second node V2.

The controller 33 connects to and controls the first to sixth switches S1-S6. The controller 33 also selectively drives the first to sixth switches S1-S6 to activate the full bridge rectifying unit 31 or the half bridge rectifying unit 32 based on comparison results between a DC voltage of the DC source 10 with a grid voltage of the grid voltage system 50.

In this embodiment, the output circuit 40 has a filter circuit 41 comprised of two inductors L1, L2. First ends of the two inductors L1, L2 are respectively connected to the second node V2 and the third node V3. Second ends of the two inductors L1, L2 are connected to the grid voltage system 50 as two AC output terminals AC1, AC2.

With reference to FIG. 2, when amplitude of the grid voltage (Vgrid) is smaller than that of the half DC voltage (DC/2) during the periods t0-t1 and t2-t3 in positive cycles, the sixth switch S6 is operated in a switching mode, and the third switch S3 is turned on, enabling the half bridge rectifying unit 32 to operate. When the grid voltage (Vgrid) becomes greater than the positive half DC voltage (DC/2) during the period t1-t2, the second switch S2 is operated in a switching mode, and the third switch S3 is turned on, enabling the full bridge switching unit 31 to operate. When the first, second, fourth to sixth switches S1, S2, S4-S6 are turned off and the fourth diode D4 and the third switch S3 are turned on, the half/full bridge switchable circuit 30 outputs a freewheeling current during the positive cycles.

When amplitude of the grid voltage (Vgrid) is smaller than that of the half DC voltage (−DC/2) during the periods t3-t4 and t5-t6 in negative cycles, the fifth switch S5 is operated in a switching mode, the fourth switch S4 is turned on, enabling the half bridge rectifying unit 32 to operate. When amplitude of the grid voltage (Vgrid) becomes greater than that of the half DC voltage (−DC/2) during the period t4-t5 in negative cycles, the first switch S1 is operated in a switching mode, and the fourth switch S4 is turned on, enabling the full bridge switching unit 31 to operate. When the first, second, third, fifth and sixth switches S1, S2, S3, S5, S6 are turned off and the third diode D3 and the fourth switch S4 are turned on, the half/full bridge switchable circuit 30 outputs a freewheeling current during the negative cycles.

In summary, when the amplitude of the grid voltage (Vgrid) is smaller than that of the half DC voltage (DC/2) in both the positive and negative cycles, the half bridge rectifying unit 32 is enabled and operates in a buck mode, wherein the third and sixth switches S3, S6 are operated for positive cycles, and the fourth and fifth switches S4, S5 are operated for negative cycles.

With reference to FIG. 3, a second embodiment of the hybrid DC/AC inverter differs from the first embodiment in removing the original diodes in parallel to the first and second switches S1, S2. Further, the output circuit 40 further includes a third by-pass diode D3, a fourth by-pass diode D4, a seventh switch S7 and a eighth switch S8. The seventh switch S7 is connected between the third switch S3 and the third node V3. The eighth switch S8 is connected between the fourth switch S4 and the third node V3. The third by-pass diode D3 has its anode connected to the second node V2, and its cathode connected to a node between the third and seventh switches S3, S7. The fourth by-pass diode D4 has its cathode connected to the second node V2, and its anode connected to a node between the fourth and eighth switches S4, S8.

The operations of the second embodiment are similar to that of the first embodiment. When the of the grid voltage (Vgrid) is smaller than the half DC voltage (DC/2) in positive cycles, the third switch and sixth switch S3, S6 are operated in a switching mode, and the seventh switch S7 is turned on, enabling the half bridge rectifying unit 32 to operate. When the third and sixth switches S3, S6 are turned off and the third diode D3 and the seventh switch S7 are turned on, the output circuit 40 outputs a freewheeling current. When the grid voltage (Vgrid) becomes greater than the half DC voltage (DC/2) in positive cycles, the second switch and third switch S2, S3 are operated in a switching mode, and the seventh switch S7 is turned on, enabling the full bridge switching unit 31 to operate. When the second and third switches S2, S3 are turned off and the third diode D3 and the seventh switch S7 are turned on, the output circuit 40 outputs a freewheeling current.

When amplitude of the grid voltage (Vgrid) is smaller than that of the half DC voltage in negative cycles, the fourth switch and fifth switch S4, S5 are operated in a switching mode, and the eighth switch S8 is turned on, enabling the half bridge rectifying unit 32 to operate. When the fourth and fifth switches S4, S5 are turned off and the fourth diode D4 and the eighth switch S8 are turned on, the output circuit 40 outputs a freewheeling current. When amplitude of the grid voltage (Vgrid) becomes greater than that of the half DC voltage in negative cycles, the first switch and fourth switch S4, S4 are operated in a switching mode, and the eighth switch S8 is turned on, enabling the full bridge switching unit 31 to operate. When the fourth and first switches S4, S1 are turned off and the fourth diode D4 and the eighth switch S8 are turned on, the output circuit 40 outputs a freewheeling current.

In summary, when the amplitude of the grid voltage (Vgrid) is smaller than that of the half DC voltage (DC/2) in either positive or negative cycles, the half bridge rectifying unit 32 is enabled and operates in a buck mode, wherein the third, sixth and seventh switches S3, S6, S7 are operated for positive cycles, and the fourth, fifth, eighth switches S4, S5, S8 are operated for negative cycles.

With reference to FIG. 4, a third embodiment of the hybrid DC/AC inverter differs from the first embodiment in removing the original diodes in parallel to the first and second switches S1, S2. The output circuit 40 further includes a third diode D3, a fourth diode D4, a seventh switch S7 and a eighth switch S8. The seventh switch S7 is connected between the third node V3 and the cathode of the third diode D3. The anode of the third diode D3 is connected to the second node V2. The eighth switch S8 is connected between the second node V2 and the cathode of the fourth diode D4. The anode of the fourth diode D4 is connected to the third node V3.

When amplitude of the grid voltage (Vgrid) is smaller than that of the half DC voltage (DC/2) in positive cycles, the third and sixth switches S3, S6 are operated in a switching mode, enabling the half bridge rectifying unit 32 to operate. When the third and sixth switches S3, S6 are turned off and the third diode D3 and the seventh switch S7 are turned on, the output circuit 40 outputs a freewheeling current. When the grid voltage (Vgrid) becomes greater than the positive half DC voltage (DC/2) in positive cycles, the second and third switches S2, S3 are operated in a switching mode, enabling the full bridge switching unit 31 to operate. When the third and second switches S3, S2 are turned off and the third diode D3 and the seventh switch S7 are turned on, the output circuit 40 outputs a freewheeling current.

When amplitude of the grid voltage (Vgrid) is smaller than that of the half DC voltage (−DC/2) in negative cycles, the fourth and fifth switches S4, S5 are operated in a switching mode enabling the half bridge rectifying unit 32 to operate. When the fourth and fifth switches S4, S5 are turned off and the fourth diode D4 and the eighth switch S8 are turned on, the output circuit 40 outputs a freewheeling current. When amplitude of the grid voltage (Vgrid) becomes greater than that of the half DC voltage (−DC/2) in negative cycles, the first and fourth switches S1, S4 are operated in a switching mode, enabling the full bridge switching unit 31 to operate. When the fourth and first switches S4, S1 are turned off and the fourth diode D4 and the eighth diode S8 are turned on, the output circuit 40 outputs a freewheeling current.

In summary, when the amplitude of the grid voltage (Vgrid) is smaller than that of the half DC voltage (DC/2) in either positive or negative cycles, the half bridge rectifying unit 32 is enabled and operates in a buck mode, wherein the third and sixth switches S3, S6 are operated for positive cycles, and the fourth and fifth switches S4, S5 are operated for negative cycles.

With reference to FIG. 5, a fourth embodiment of the hybrid DC/AC inverter differs from the first embodiment in removing the original diodes in parallel to the first and second switches S1, S2. The output circuit 40 further including a third diode D3, a fourth diode D4, a seventh switch S7 and a eighth switch S8. The seventh switch S7 is connected between the third switch S3 and the third node V3. The third by-pass diode D3 has its anode connected to the second node V2, and its cathode connected to a node between the third and seventh switches S3, S7. The eighth switch S8 is connected between the second node V2 and the cathode of the fourth diode D4. The fourth diode D4 has its anode connected to the third node V3.

When the grid voltage (Vgrid) is smaller than that of the half DC voltage (DC/2) in positive cycles, the third switch and sixth switch S3, S6 are operated in a switching mode, and the seventh switch S7 is turned on, enabling the half bridge rectifying unit 32 to operate. When the third and sixth switches S3, s6 are turned off and the third diode D3 and the seventh switch S7 are turned on, the output circuit 40 outputs a freewheeling current. When the grid voltage (Vgrid) becomes greater than the half DC voltage (DC/2) in positive cycles, the second switch and third switch S2, S3 are operated in a switching mode, and the seventh switch S7 is turned on, enabling the full bridge switching unit 31 to operate. When the third and second switches S3, S2 are turned off and the third diode D3 and the seventh switch S7 are turned on, the output circuit 40 outputs a freewheeling current.

When amplitude of the grid voltage (Vgrid) is smaller than that of the half DC voltage in negative cycles, the fourth switch and fifth switch S4, S5 are operated in a switching mode, enabling the half bridge rectifying unit 32 to operate. When the fourth and fifth switches S4, S5 are turned off and the fourth diode D4 and the eighth switch S8 are turned on, the output circuit 40 outputs a freewheeling current. When amplitude of the grid voltage (Vgrid) becomes greater than that of the half DC voltage in negative cycles, the firth switch and fourth switch S1, S4 are operated in a switching mode, enabling the full bridge switching unit 31 to operate. When the fourth and first switches S4, S1 are turned off and the fourth diode D4 and the eighth switch S8 are turned on, the output circuit 40 outputs a freewheeling current.

In summary, when the amplitude of the grid voltage (Vgrid) is smaller than that of the half DC voltage (DC/2) in either positive or negative cycles, the half bridge rectifying unit 32 is enabled and operates in a buck mode, wherein the third, sixth and seventh switches S3, S6, S7 are operated for positive cycles, and the fourth and fifth switches S4, S5 are operated for negative cycles.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hybrid DC/AC inverter for connecting between a DC source (10) and a grid voltage system (50), the inverter comprising:
an input circuit (20) having a positive input terminal (+DC), a negative input terminal (−DC) and two capacitors (C1,C2), wherein the two capacitors (C1, C2) have their first ends connected together to form a first node (V1) and their second ends respectively connected to the positive input terminal (+DC) and the negative input terminal (−DC);
a half/full bridge switchable circuit (30) comprising
a full bridge switching unit (31) connected to the positive input terminal (+DC) and the negative input terminal (−DC) and including first to fourth switches (S1-S4);
wherein the first switch (S1) and the second switch (S2) have their one ends connected together to form a second node V2 and their the other ends respectively connected to the positive input terminal (+DC) and the negative input terminal (−DC); and
the third switch (S3) and the fourth switch (S4) have their one ends connected together to form a third node (V3) and their the other ends respectively connected to the positive input terminal (+DC) and the negative input terminal (−DC);
a half rectifying unit (32) including the first switch (S1) and the second switch (S2) commonly used with the full bridge switching unit (31) and further including fifth switch (S5), a sixth switch (S6), a first by-pass diode (D1) and a second by-pass diode (D2);
wherein the fifth switch (S5) and the sixth switch (S6) are connected in series between the first node (V1) and the second node (V2), and the first and second by-pass diodes (D1, D2) are connected in parallel to the fifth switch (S5) and the sixth switch (S6) respectively, and cathodes of the first and second by-pass diodes (D1, D2) are respectively connected to the first node (V1) and the second node (V2);
a controller (33) connected to the first to sixth switches (S1-S6).

2. The hybrid DC/AC inverter as claimed in claim 1 further comprising:
an output circuit (40) including a filter circuit (41) comprised of two inductors (L1,L2), wherein first ends of the two inductors (L1, L2) are respectively connected to the second node (V2) and the third node (V3), and second ends of the two inductors (L1, L2) are for connecting to the grid voltage system (50) as two AC output terminals (AC1, AC2).

3. The hybrid DC/AC inverter as claimed in claim 2, wherein the output circuit (40) further comprises a third by-pass diode (D3), a fourth by-pass diode (D4), a seventh switch (S7) and a eighth switch (S8);
the seventh switch (S7) is connected between the third switch (S3) and the third node (V3);
the eighth switch (S8) is connected between the fourth switch (S4) and the third node (V3);
the third by-pass diode (D3) has its anode connected to the second node (V2), and its cathode connected to a node where the third and seventh switches (S3, S7) connect together; and
the fourth by-pass diode (D4) has its cathode connected to the second node (V2), and its anode connected to a node wherein the fourth and eighth switches (S4, S8) connect together.

4. The hybrid DC/AC inverter as claimed in claim 2, wherein the output circuit (40) further comprises a third by-pass diode (D3), a fourth by-pass diode (D4), a seventh switch (S7) and a eighth switch (S8);
the seventh switch (S7) is connected between the third node (V3) and a cathode of the third diode (D3);
an anode of the third diode (D3) is connected to the second node (V2);
the eighth switch (S8) is connected between the second node (V2) and a cathode of the fourth diode (D4); and
an anode of the fourth diode (D4) is connected to the third node (V3).

5. The hybrid DC/AC inverter as claimed in claim 2, wherein the output circuit (40) further comprises a third by-pass diode (D3), a fourth by-pass diode (D4), a seventh switch (S7) and a eighth switch (S8);
the seventh switch (S7) is connected between the third switch (S3) and the third node (V3);
the third by-pass diode (D3) has its anode connected to the second node (V2), and its cathode connected to a node where the third and seventh switches (S3, S7) connect together;
the eighth switch (S8) is connected between the second node (V2) and a cathode of the fourth by-pass diode (D4); and
the fourth by-pass diode (D4) has its anode connected to the third node V3.
